(19) United States
(12) Patent Application Publication
(10) Pub. No.: US 2022/0385073 A1
(43) Pub. Date: Dec. 1, 2022

(54) POWER MONITORING AND CONTROL SYSTEM WHICH DETERMINES A PERFORMANCE PARAMETER OF AN ELECTRICAL LOAD

(71) Applicant: Minesh Bhakta, Paradise Valley, AZ (US)

(72) Inventor: Minesh Bhakta, Paradise Valley, AZ (US)

(21) Appl. No.: 17/330,390

(22) Filed: May 25, 2021

(51) Int. Cl. H02J 3/38; H02J 7/00; H02J 13/00

(52) U.S. Cl. CPC H02J 3/381; H02J 7/0068; H02J 13/00002; H02J 2300/24

(57) ABSTRACT

The invention involves an energy monitoring and control system that monitors and controls the peak energy demand so that demand charges are reduced. The system includes an electrical load which receives an aggregate power signal having grid, battery, and solar power supply components. An energy monitoring panel determines the grid and solar power components. A battery-demand modulator panel determines a charge cycle for a battery power supply. An energy gateway processor receives information from the battery-demand modulator panel regarding the charge cycle for the battery power supply and information from the energy monitoring panel regarding the grid and solar power components. The battery-demand modulator panel modulates the charge cycle for the battery power supply, in response to a signal from the energy gateway processor, to adjust the battery power supply component of the aggregate power signal.

### BACKGROUND OF THE INVENTION

This invention relates generally to power regulation and, more particularly, to monitoring and controlling the operation of an electrical load.

Description of the Related Art

Energy monitoring and control systems are widely used to provide centralized monitoring and control of an electrical load in an electrical system. The electrical load can be of many different types, such as heating, cooling, appliances and lighting devices. It is desirable to monitor and control the electrical load to monitor and control the energy usage by the electrical load. More information regarding such systems and electrical loads is provided in the Backgrounds of the above-identified related applications. Other references to note include U.S. Pat. Nos. 5,521,838, 5,563,455, 5,880,677, 5,978,569 and 7,379,997, as well as U.S. Patent Application Nos. 20060120008 and 20080031026.

Control systems, such as a load controller, are available for controlling household appliances from a central location. Some of these control systems use a power line modem, which is a transmitter/receiver capable of operating over conventional AC 120/240 volt (V) power lines (power mams). Alternately, some control systems use standardized wireless communication protocols. Examples of these types of control systems are disclosed in U.S. Pat. Nos. 4,174,517 and 4,418,333. In some of these control systems, a control unit is programmed to control a desired function within various electrical loads depending upon the time of day. For example, the control unit can control the operation of a lighting device and/or appliance.

Demand charges are a big part of an electrical bill and utility companies use them to encourage people to manage peak energy demand. A such, it is desirable to have an energy monitoring and control system that monitors and controls the peak energy demand so that demand charges are reduced.

### BRIEF SUMMARY OF THE INVENTION

The present invention involves an energy monitoring and control system that monitors and controls the peak energy demand so that demand charges are reduced. The invention will be best understood from the following description when read in conjunction with the accompanying drawings.

### BRIEF DESCRIPTION OF THE DRAWINGS

FIG. 1 is a block diagram of one embodiment of an energy monitoring and control system.

FIG. 2 is a block diagram of a battery-demand modulator panel of the energy monitoring and control system of FIG. 1.

FIG. 3 is a block diagram of an alternative embodiment of a battery-demand modulator panel of the energy monitoring and control system of FIGS. 1 and 2.

FIG. 4 is a battery-solar graph of power consumption (Watts) verses one-hour time intervals in a day, wherein the power corresponds to battery power, grid power, and solar power of the energy monitoring and control system of FIG. 1.

FIG. 5 is a pie chart of total daily power consumption (%) verses time (Days, Week, Month), wherein the power corresponds to battery power, grid power, and solar power of the energy monitoring and control system of FIG. 1.

FIG. 6 is a consumption-battery graph of consumption and battery power draw (Watts) verses 10-minute time intervals, wherein the consumption corresponds to total electricity being consumed by the house and battery power draw is being matched to consumption resulting in zero grad demand by the energy monitoring and control system of FIG. 1.

### DETAILED DESCRIPTION OF THE INVENTION

Disclosed herein are several systems which monitor and/or control the operation of one or more electrical loads. This is desirable because, for many different reasons, the operation of an electrical load is expensive. One reason the operation is expensive is because electrical power is expensive and the general trend is for it to increase in cost. As mentioned above, demand charges are a big part of an electrical bill and utility companies use them to encourage people to manage peak energy demand.

Hence, the energy monitoring and control system disclosed herein monitors and controls the peak energy demand so that demand charges are reduced. In some situations, the energy monitoring and control system provides notifications regarding the amount of energy usage and costs. Further, the energy monitoring and control system draws a calculated amount of power from different power systems to reduce the demand charges to a preset level. For example, in some embodiments, the different power systems include a solar power system, battery power system, and a grid power system. With control of power draw, the battery system, for example, can extend the use of solar power through the fill peak demand period to reduce demand charges. Demand charges are reduced because the battery power system and solar power system are operated in a controlled manner to reduce the amount of power drawn from the grid power system. The systems disclosed herein allow the reduction of demand charges and power bills with managed battery powered.

An advantage of the energy motoring and control system is that most off-the-shelf battery power systems and compatible battery chargers can be paired therewith to avoid premium charges for proprietary systems. Further, most grid-tied solar inverters can be paired to the energy monitoring and control system to avoid specialized high-cost battery inverters.

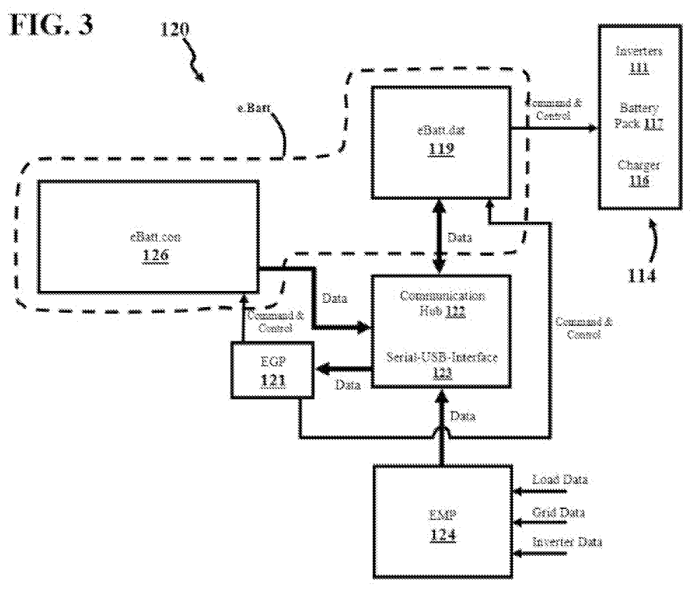

The energy monitoring and control system provides flexible configurations which allow the end user to tailor the control algorithms to budgetary needs so that the return on investment can be adjusted. Since the energy monitoring and control system provides more control over battery power usage, the end user can adjust the return on the solar power system. The energy monitoring and control system is also compatible with solar-battery and back-up-battery systems. These solar-battery and back-up-battery systems may allow setting the output from the battery in their configuration menu, but they do not automatically adjust the battery draw to minimize demand like the energy monitoring and control system. The energy monitoring and control system uses its monitoring data, analytics, and communication capability to manage solar-battery and back-up-battery systems to adjust the power draw and allow the battery to last through the fall peak period and minimize demand charges. In this energy monitoring and control system embodiment, some of the hardware elements are not necessary, as shown in FIG. 3, since they may be already integrated in the solar-battery or back-up-batter systems.

Unfortunately, most peak power demand periods extend beyond when the solar power system stops generating. The energy monitoring and control system includes algorithms which determine when it makes most sense to charge the battery power system and conserve some solar power so that it can be used to lower the peak power demand as the solar generation is reduced. The solar generation is reduced, for example, when the sun sets or when a cloud blocks the sun.

The energy monitoring and control system includes a software dashboard that displays data in an easily understandable format which will help the end user optimize the system operation to meet budgetary requirements.

The system is useful in many different settings. For example, it can be used at home, in an office, or another setting to monitor and control the operation of electrical loads typically used in these places. The electrical load can be any type of electrical load, such as an appliance, television, computer, air conditioner, lamp, hair drier, refrigerator, etc. which are generally powered by an electrical outlet. The system can also include wireless sensors, such as a motion sensor, smoke detector, temperature sensor, air pressure quality sensor, and a switch sensor.

In one particular example, the system is used to monitor and control the electrical loads in the rooms of a hotel. If the room is currently unoccupied, then the system can turn one or more of the electrical loads in this room off to reduce operating costs. If the room is going to be occupied, then one or more of the electrical loads in the room can be provided with power by the system so they can be used by the occupants. If the room is currently being occupied, then the system can monitor and or control the operation of the devices.

In another example, the system is used to determine the amount of power consumed over a particular period of time by the electrical loads in an office, home, or another building. This is desirable because sometimes there are two rates for electrical power, a low rate and a high rate. In some instances, the low rate is paid when the total power usage is below a predetermined threshold power value and the high rate is paid when the total power usage is above the predetermined threshold power value. Since it is desirable for the consumer to pay the lower rate, the system can be used to determine the total power usage so it can be compared to the predetermined threshold power value. In this way, the consumer will know how much power they can use before they go above the threshold power value and have to pay the higher rate.

More information regarding the energy monitoring and control systems discussed herein can be found in U.S. patent application Ser. Nos. 11/178,822, 11/925,690, 13/345,699, 14/922,978, and 15/658,915, the contents of all of which are incorporated by reference as though fully set forth herein.

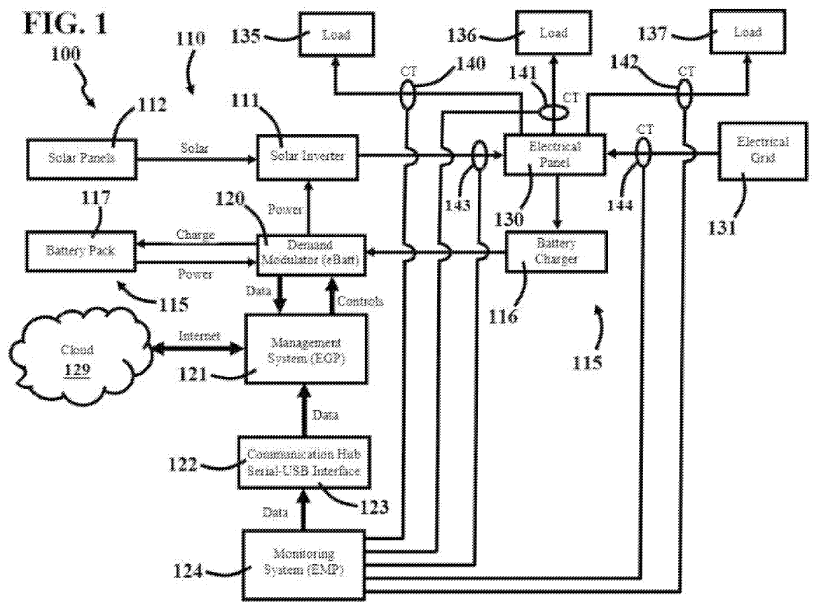

FIG. 1 is a block diagram of one embodiment of an energy monitoring and control system 100. It should be noted that like reference characters are used throughout the several views of the Drawings.

In this embodiment, the energy monitoring and control system 100 includes a battery-demand modulator panel (eBATT) 120, wherein the battery-demand modulator panel 120 is in communication with a battery power system 115. The battery power system 115 can be of marry different types. In this embodiment, the battery power system 115 includes a battery pack 117 and battery charger 116. The battery pack 117 can be of many different types. In general, the battery pack 117 includes one or more rechargeable batteries.

In operation, the battery charger 116 provides a first battery charge signal to the battery-demand modulator panel 120. Further, the battery-demand modulator panel 120 provides a second battery charge signal to the battery pack 117 and the battery pack 117 is charged in response. The battery pack 117 provides a battery power signal to the battery-demand modulator panel 120. In this way, the battery-demand modulator panel 120 determines the battery charge status of the battery power system 115 and the power being supplied thereto.

In this embodiment, the energy monitoring and control system 100 includes a solar power system 110, wherein the battery-demand modulator panel 120 is in communication with the solar power system 110. The solar power system 110 can be of many different types. In this embodiment, solar power system 110 includes a solar inverter 111 and solar panels 112. The solar panels 112 can be of many different types. In general, the solar panels 112 includes one or more solar panels.

In operation, the solar panels 112 provides a first solar power signal to the battery-demand modulator panel 120. Further, the battery-demand modulator panel 120 provides a second solar power signal.

In this embodiment, the battery-demand modulator panel 120 is in communication with a management system 121, wherein the management system 121 is in communication with a communication hub 122. In this embodiment, the communication hub 122 is in communication with a energy monitoring panel (EMP) 124. The management system 121 includes an energy gateway processor (EGP) and the energy monitoring panel (EMP) 124 includes an energy monitoring panel (EMP).

In this embodiment, the solar inverter 111 is in communication with an electrical panel 130. Further, the battery charger 116 is in communication with the electrical panel 130. The electrical panel 130 can be of many different types, such as those used to provide electrical service to a location, such as a building. The building can be of many different types, such as a residential home and a commercial building. Examples of commercial buildings include business offices, hotels, shopping malls, restaurants, food storage facilities, etc. The electrical panel 130 is in communication with an electrical grid 131, wherein the electrical grid 131 provided electrical power thereto. In general, the electrical grid 131 is operated by a utility company.

In this embodiment, one or more loads 135, 136, 137 is(are) in communication with the electrical panel 130. The load(s) 135, 136, 137 can be of many different types, such as an air conditioner, light, refrigeration unit, heater, battery, and electrical tool, among others. In general, the load(s) 135, 136, 137 operate with electrical power. The energy monitoring panel (EMP) of the energy monitoring panel (EMP) 124 determines the power from the grid power supply 131 and solar power system 110 used by the electrical loads 135, 136, and 137.

In this embodiment, one or more sensors are operatively coupled with a load. The load can be of many different types, such as the loads 135, 136, and/or 137. The sensor can be of many different types, such as a current sensor, which determines a current flow through the corresponding load. The current sensor can be of many different types, such as a current transformer (CT).

In this embodiment, a current transformer 140 is operatively coupled with the load 135 and the energy monitoring panel (EMP) 124. The current transformer 140 provides a first current signal to the energy monitoring panel (EMP) 124 in response to a current flowing between the electrical panel 130 and load 135.

In this embodiment, a current transformer 141 is operatively coupled with the load 136 and the energy monitoring panel (EMP) 124. The current transformer 141 provides a second current signal to the energy monitoring panel (EMP) 124 in response to a current flowing between the electrical panel 130 and load 136.

In this embodiment, a current transformer 142 is operatively coupled with the load 137 and the energy monitoring panel (EMP) 124. The current transformer 142 provides a third current signal to the energy monitoring panel (EMP) 124 in response to a current flowing between the electrical panel 130 and load 137.

In this embodiment, a current transformer 143 is operatively coupled with the solar inverter 111 and the energy monitoring panel (EMP) 124. The current transformer 143 provides a fourth current signal to the energy monitoring panel (EMP) 124 in response to a current flowing between the electrical panel 130 and solar inverter 111.

In this embodiment, a current transformer 144 is operatively coupled with the electrical grid 131 and the energy monitoring panel (EMP) 124. The current transformer 144 provides a fifth current signal to the energy monitoring panel (EMP) 124 in response to a current flowing between the electrical panel 130 and electrical grid 131.

In the operation of the power monitoring and control system 100, the management system 121 includes an integral energy gateway processor which receives data from one or more on-board monitoring nodes current transformers 140, 141, 142, 143, 144, which includes Taras technology that provides electrical data. The Taras technology is provided by Akida, LLC of Arizona. In some embodiments, the electrical data is received in real-time. The management system (EGP) 121 software has an application programming interface (API) so that the granular, real-time data can be streamed to any analytical platform.

The battery-demand modulator panel 120 is installed proximate to the battery pack 117 and a grid-tied solar inverter 111. The battery pack 117 is connected to the battery-demand modulator panel 120. The battery charger 116 is connected to power and the battery charger 116 output is also connected to the battery-demand modulator panel 120. The battery demand modulator panel 120 output is connected to the grid-tied solar inverter 111 which is connected to the electrical panel 130. The energy monitoring panel (EMP) 124 uses current transformers 140, 141, 142, 143, 144 to determine the total power consumption and the solar power generation. The energy monitoring panel (EMP) 124 determines the total power consumption from the first, second, third, fourth, and fifth currents.

The management system (EGP) 121 operates a software Application which performs analytics on the data and generates notifications and relay control commands based on limits established in a system configuration. The Application is provided by Akida, LLC of Arizona. The configuration of the power monitoring and control system 100 can be set by an installer and/or end user. The configuration of the power monitoring and control system 100 can be changed by the installer and/or end user if different limits are desired.

In some embodiments, the management system (EGP) 121 is Internet-of-Things (IOT) enabled for access to the internet, such as a Cloud 129. The management system (EGP) 121 connects to the Internet via Ethernet, WiFi or cellular modem. Although data gathering, processing and analytics is local, the Cloud 129 is used for access, data backups, software updates, weather and other data, diagnostics-troubleshooting and connectivity with platforms such as Alexa.

The Application has a version that runs on mobile devices and it communicates with the management system (EGP) 121 via the Cloud 129 for a “on-the-go” dashboard view and notifications. The Application allows total customization to meet User requirements and can also have saved “easy button” set-it-and-forget-it configurations. The Application determines the total power usage and solar power generation to limit power draw from the battery pack 117. The Application adjusts the draw from the battery pack 117 in response to determining the total power usage and solar power generation. The Application reduces the likelihood that the battery pack 117 will be discharged below a predetermined battery power amount. For example, it is desirable to prevent the battery pack 117 from discharging below the predetermined battery power amount before the end of the peak period. Hence, the Application operates with the power monitoring and control system 100 to reduce demand charges and power bills with managed battery powered.

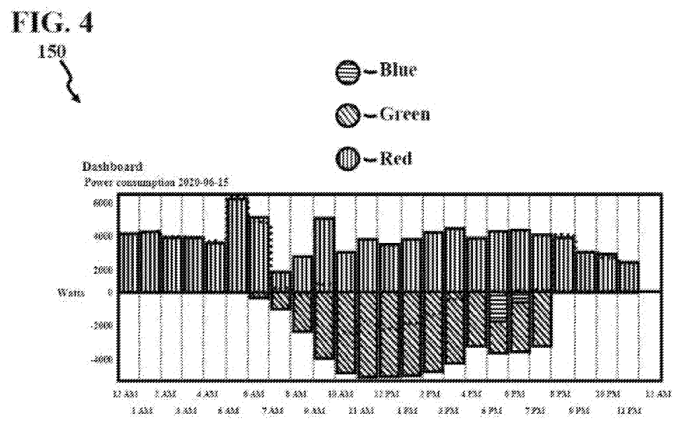

As shown in FIG. 4, the power draw from the battery pack 117 is modulated so that, during peak period, battery use is increased and grid demand is reduced. For example, the Application increases the power draw from the battery pack 117 in response to an indication that grid supplied power costs an amount above a predetermined cost limit.

The system monitors renewable power generation and includes this data in calculations. In some embodiments, the renewable power generation includes solar power provided by the solar power system 110. As mentioned above, a typical solar power system 110 includes one or more solar panels 112 connected to the solar inverter 111.

The power monitoring and control system 100 controls the charge cycle for the battery pack 117 with an on-board relay and this optimizes use of solar power during peak period when grid power is most expensive. The Application can use Artificial Intelligence (AI) to identify patterns in power consumption to maintain enough reserve capacity in the battery pack 117 to last through the peak period and not allow a spike in the peak demand. Demand charges are often based on one-time peak demand, so it is desirable to control the peak demand and reduce demand charges.

The Application can also operate an eLOK Demand Control which provides the added value of automated control of non-critical electrical loads 135, 136, 137. This allows further reduction of total demand, enabling the battery to last longer. As mentioned above, the pairing of these two systems can bring peak demand to zero to maximize savings. The eLOK Demand Control is provided by Akida, LLC of Arizona.

The Application is capable of making adjustments to the operation of the system in response to environmental changes. For example, the Application can make adjustments to the operation of the system in response to receiving weather information. Examples of weather information include cloud cover, rain, temperature, etc. Further, the Application can make adjustments to the operation of the system in response to receiving seasonal information. Examples of seasonal information include the position of the sun, the time of sunrise, the time of sunset, etc. The seasonal information is known to change throughout the year. The weather and seasonal information can be provided to the Application, such as through an internet connection. In some embodiments, the weather and seasonal information is received by the Application from the Cloud.

In some situations, the energy gateway processor (EGP) 121 receives information from the battery-demand modulator panel (eBATT) 120 regarding the battery charge status of the battery power system 115 and the power being supplied thereto and information from the energy monitoring panel (EMP) 124 regarding the power from the grid power supply 131 and solar power system 110 used by the electrical load 135, 136, and 137.

The battery-demand modulator panel (eBATT) 120 can modulate the battery power system 115, in response to a signal from the energy gateway processor (EGP) 121, to adjust the grid power 131 used by the electrical loads 135, 136, and 137. In some embodiments, the battery-demand modulator panel (eBATT) 120 reduces the grid power used by the electrical loads 135, 136, 137 during peak periods to reduce the cost.

The battery-demand modulator panel (eBATT) 120 can increases the battery power supply used during peak periods to reduce the cost. In some embodiments, the battery-demand modulator panel (eBATT) 120 adjusts the battery power during peak demand periods to reduce demand charges. Further, the battery-demand modulator panel (eBATT) 120 can increases the battery power as the solar power decreases.

The energy gateway processor (EGP) 121 can determine the battery power supplied in response to determining the total power used by the electrical loads 135, 136, and 137 and solar power supplied. In some embodiments, the operation of the battery power system 115 is adjusted by the energy gateway processor (EGP) 121 in response to adjustments in solar power provided by the solar power system 110.

The energy monitoring panel (EMP) 124 can determine the grid and solar power components. In some embodiments, the battery-demand modulator panel (eBATT) 120 determines a charge cycle for the battery power system 115.

In some embodiments, the energy gateway processor (EGP) 121 receives information from the battery-demand modulator panel (eBATT) 120 regarding the charge cycle for the battery power system 115 and information from the energy monitoring panel (EMP) 124 regarding the grid and solar power components of the aggregate power signal.

In some embodiments, the battery-demand modulator panel (eBATT) 120 modulates the charge cycle for the battery power system 115, in response to a signal from the energy gateway processor (EGP) 121, to adjust the battery power supply component of the aggregate power signal.

The battery-demand modulator panel (eBATT) 120 can reduce the grid power supply component during peak periods to reduce the cost. Further, the battery-demand modulator panel (eBATT) 120 can increase the battery power supply component used during peak periods to reduce the cost.

The battery-demand modulator panel (eBATT) 120 can adjust the battery power supply component during peak demand periods to reduce demand charges. Further, the battery-demand modulator panel (eBATT) 120 can increase the battery power supply component as the solar power supply component decreases.

In some embodiments, the energy gateway processor (EGP) 121 determines the battery power supply component in response to determining the grid and solar power supply components. The energy monitoring panel (EMP) 124 can determine the grid and solar power components at a predetermined rate. The predetermined rate can be adjustable in response to an indication that the grid and solar power components are changing.

In another embodiment, the power monitoring and control system 100 includes a plurality of electrical loads 135, 136, and 137, each of which receives an aggregate power signal having grid, battery, and solar power supply components.

The power monitoring and control system 103 includes a plurality of relays operatively coupled to corresponding electrical loads 135, 136, 137 of the plurality of electrical loads 135, 136, and 137. In this embodiment, the battery-demand modulator panel 120 determines a charge cycle for a battery power system 115.

The energy gateway processor of the management system 121 receives information from the battery-demand modulator panel 120 regarding the charge cycle for the battery power system 115 and information from the energy monitoring panel (EMP) 124 regarding the grid and solar power components.

The energy gateway processor of the management system 121 adjusts the operation of the relays and the battery-demand modulator panel 120 modulates the charge cycle for the battery power system 115, in response to a signal from the energy gateway processor (EGP) 121, to adjust the battery power supply component of the aggregate power signal to provide a desired aggregate power signal.

In some embodiments, the energy gateway processor of the management system 121 limits the aggregate power signal in response to an indication that the aggregate power signal exceeds a predetermined power value.

In some embodiments, the energy gateway processor of the management system 121 limits the aggregate power signal in response to an indication that the aggregate power signal exceeds a predetermined monetary value. The pertinent data is gathered at very high frequency and a network is created to use this data in algorithms at the energy gateway processor of the management system 121 for fully automated control of the power drawn from the battery power system 115.

In some embodiments, the energy gateway processor of the management system 121 operates the battery-demand modulator panel 120 so that the battery power supply is enabled to operate through a set tune period.

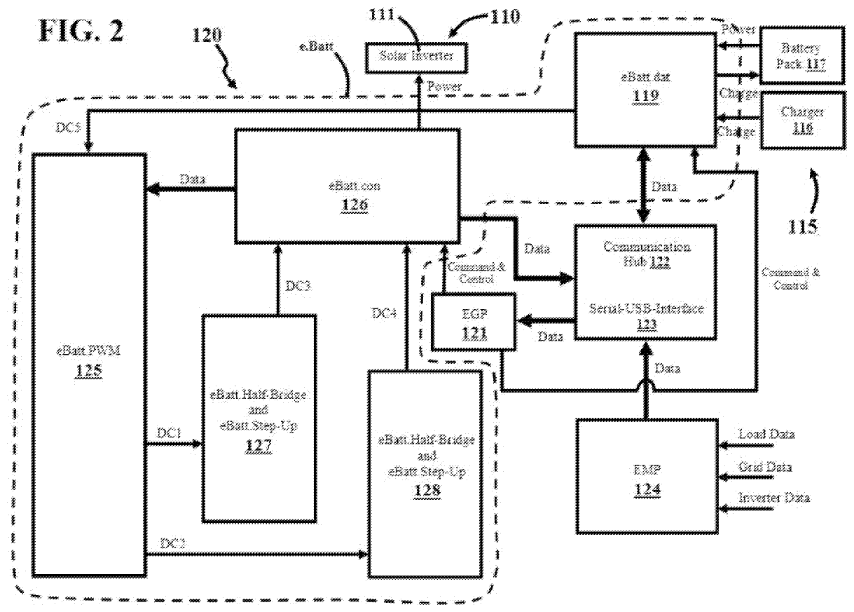

FIG. 2 is a block diagram of the battery-demand modulator panel 120 of FIG. 1. In this embodiment, the battery-demand modulator panel 120 includes a controller (eBatt.con) 126, which provides Data to various other components, as will be discussed in more detail below. The battery-demand modulator panel 120 includes a pulse wave modulator (eBatt.PWM) 125, which receives a first data signal from the controller 126. The controller 126 flows the solar power signal to the solar inverter 111.

In this embodiment, the battery-demand modulator panel 120 includes a first converter 127 which receives a first voltage signal DC1 from the pulse wave modulator 125 and provides a voltage signal DC3 to the controller 126. Further, the battery-demand modulator panel 120 includes a second converter 128 which receives a second voltage signal DC2 from the pulse wave modulator 125 and provides a voltage signal DC4 to the controller 126.

In this embodiment, the communication hub 122 (FIG. 1) receives a second data signal from the controller 126. The battery-demand modulator panel 120 includes a converter 119, which receives a third data signal from the communication hub 122. The converter 119 receives the power signal from the battery pack 117 and sends the charge signal to the battery pack 117. Further, the converter 119 receives the charge signal from the battery charger 116.

In this embodiment, the serial USB interface 123 (FIG. 1) provides a fourth data signal to the energy gateway processor (EGP) of the management system 121. The management system 121 provides a first command and control signal to the controller (eBatt.con) 126 and a second command and control signal to the converter 119. The energy monitoring panel of the monitoring system 124 receives signals Load Data, Grid Data, and Inverter Data from the load(s), electrical grid, and inverter, and provides a fifth data signal to the serial USB interface 123.

FIG. 3 is a block diagram of an alternative embodiment of the battery-demand modulator panel 120 of FIGS. 1 and 2. In this alternative embodiment, the battery-demand modulator panel 120 includes the controller (eBatt.con) 126, which provides Data to various other components, as discussed in more detail herein.

In this embodiment, the communication hub 122 (FIG. 1) receives the second data signal from the controller 126. The battery-demand modulator panel 120 includes the converter 119, which receives the third data signal from the communication hub 122.

In this embodiment, the serial USB interface 123 (FIG. 1) provides the fourth data signal to the energy gateway processor (EGP) of the management system 121. The management system 121 provides the first command and control signal to the controller (eBatt.con) 126 and the second command and control signal to the converter 119.

The energy monitoring panel of the monitoring system 124 receives signals Load Data, Grid Data, and Inverter Data from the load(s), electrical grid, and inverter, and provides a fifth data signal to the serial USB interface 123.

In this embodiment, the battery-demand modulator panel 120 includes a hybrid power system 114. The hybrid power system 114 can be of many different types. In this embodiment, the hybrid power system 114 includes the inverter 111, battery pack 117, and charger 116. The hybrid power system 114 includes the inverter 111, battery pack 117, and charger 116 as a single unit for illustrative purposes. In the energy monitoring and control system embodiment of FIGS. 1 and 3, the hardware elements of the hybrid power system 114 are integrated together.

The converter 119 provides a command and control signal to the hybrid power system 114 and the hybrid power system 114 operates in response.

The hybrid power system 114 provides a flexible configuration which allows the end user to tailor the control algorithms to budgetary needs so that the return on investment can be adjusted. The energy monitoring and control system 100 of FIG. 1 and the battery-demand modulator panel 120 of FIG. 3 provide more control over battery power usage so that the end user can adjust the return on the solar power system. The battery-demand modulator panel 120 of FIG. 3 is also compatible with various third party solar-battery and back-up-battery systems. These third party solar-battery and back-up-battery systems may allow setting the output from the battery in their configuration menu, but they do not automatically adjust the battery draw to minimize demand like the eBATT system. The energy monitoring and control system 100 of FIG. 1 and battery-demand modulator panel 120 of FIG. 3 uses its monitoring data, analytics, and communication capability to manage solar-battery and back-up-battery systems to adjust the power draw and allow the battery to last through the full peak period and minimize demand charges.

FIG. 4 is a battery-solar graph 150 of power consumption (Watts) verses one-hour time intervals in a day, wherein the power corresponds to battery power, grid power, and solar power. It should be noted that the battery solar graph 150 of FIG. 3 can be displayed on many different types of displays, such as a computer screen. The battery-solar graph 150 of FIG. 3 can also be displayed on a mobile device, such as a phone and tablet. The information of the battery-solar graph 150 can be flowed to the display in many different ways, such as through the Cloud 129.

In one example, the power verses time corresponds to the power consumed by the electrical devices of a building verses the time of day. The building can be of many different types. For example, the power verses time can correspond to the power consumed by the electrical devices of a residential home verses the time of day. In another example, the power verses time can correspond to the power consumed by the electrical devices of a commercial building verses the time of day. It should be noted that the building includes the power monitoring and control system 100 discussed herein.

In the example of FIG. 4, the red bars correspond to the total power being consumed by the electrical devices of the building verses time. The greet bars correspond to the solar power (Watts) being provided to the building verses time. Further, the blue bars correspond to the battery power (Watts) being provided to the building verses time. The black dotted line corresponds to the power demand needed from the grid power supply 131. It should be noted that it is desirable to reduce the power demand needed from the grid power supply 131. In some situations, it is desirable to reduce the power demand needed from the grid power supply 131 to be zero Watts. In this way, the costs of powering the building can be reduced.

In operation, the power monitoring and control system 100 determines the amount of power being consumed by the electrical devices of the building and the amount of solar power being produced by the solar power system 110. The power monitoring and control system 100 determines the amount of power being consumed by the electrical devices by utilizing one or more current transformers, as discussed above.

In one mode of operation, the building utilizes grid power at night.

In operation, the solar power (green) increases in the morning as the sun rises. The solar power (green) of offsets grid power (red) in the morning. The solar power (green) is flowed to the electrical grid 131, as shown in FIG. 1.

Further, in operation, the power monitoring and control system 100 determines that the solar power (Green) begins to drop off as the sun sets, so more batter power (blue) is provided. The battery power system 115 (FIG. 1) provides this battery power so that the grid power demand is reduced. In some examples, the battery power offsets the reduction in solar power over time. In another example, the battery power is driven to a power value that drives the grid power supplied to zero Watts. It should be noted that the power monitoring and control system 100 determines the capacity of the battery power system 115 so that it will have battery power to a pre-set time, such as 8 pm. In general the pre-set time depends on the time the sun sets. In some examples, the pre-set time is determined by the time the grid demand rates end. The power from the electrical grid 131 costs less after the grid demand rate ends so it is desirable to use battery power to avoid using expensive grid power.

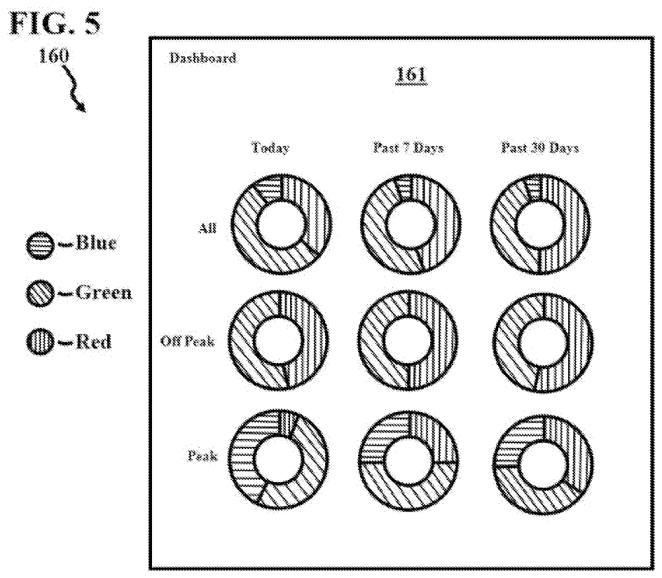

FIG. 5 is a pie chart 160 of total power consumption (%) verses time (Day, Week, Month), wherein the power corresponds to battery power, grid power, and solar power. The pie charts are in columns for days from Today, the Past 7 Days, and the Past 30 Days. Further, the pie charts are in rows for All, Off Peak time, and Peak time.

It should be noted that the pie chart 160 of FIG. 5 can be displayed on many different types of displays, such as a computer screen. The pie chart 160 of FIG. 5 can also be displayed on a mobile device, such as a phone and tablet. The information of the pie chart 160 can be flowed to the display in many different ways, such as through the Cloud 129. In this embodiment, the pie chart 160 is shown displayed on a Dashboard 160. It should be noted that the battery solar graph 150 of FIG. 4 can also be displayed on the Dashboard 161, if desired. The Dashboard 161 presents information in an easily understandable format which helps optimize the system to meet budgetary needs.

In this example for Today, All the power consumed is 55.6 percent (%) solar power (Green), 35.8% grid power (Red) and 8.6% battery power (Blue). During Today's Off Peak time, the Off Peak power consumed is 55.3 percent (%) solar power (Green), 44.7% grid power (Red) and 0.0% battery power (Blue). Further, during Today's Peak time, the Peak power consumed is 67.0 percent (%) solar power (Green), 4.7% grid power (Red) and 28.3% battery power (Blue).

In this example for the Past 7 Days. All the power consumed is 48.7 percent (%) solar power (Green), 44.6% grid power (Red) and 6.7% battery power (Blue). During the Past 7 Days Off Peak time, the Off Peak power consumed is 50.5 percent (%) solar power (Green), 49.5% grid power (Red) and 0.0% battery power (Blue). Further, during the Past 7 Days Peak time, the Peak power consumed is 46.7 percent (%) solar power (Green), 26.8% grid power (Red) and 26.5% battery power (Blue).

In this example for the Past 30 Days, All the power consumed is 44.5 percent (%) solar power (Green), 48.4% grid power (Red) and 7.1% battery power (Blue). During the Past 30 Days Off Peak time, the Off Peak power consumed is 46.6 percent (%) solar power (Green), 53.4% grid power (Red) and 0.0% battery power (Blue). Further, during the Past 30 Days Peak time, the Peak power consumed is 38.0 percent (%) solar power (Green), 34.5% grid power (Red) and 27.5% battery power (Blue).

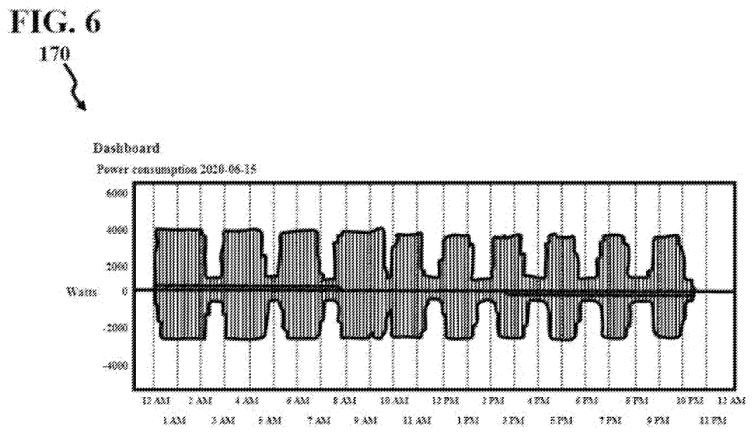

FIG. 6 is a consumption-battery graph 170 of consumption and battery power draw (Watts) verses 10-minute time intervals, wherein the consumption corresponds to total electricity being consumed by the house and battery power draw is being matched to consumption resulting in zero grid demand by the energy monitoring and control system of FIG. 1. It should be noted that demand charges correspond to All Demand Charges, Off Peak Demand Charges, and Peak Demand Charges.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

1. A system, comprising:
an electrical panel connected to an electrical load;
a grid power supply connected to the electrical panel;
a battery power supply connected to the electrical panel;
a solar power supply connected to the electrical panel;
an energy monitoring panel (EMP) which determines the power from the grid and solar power supplies used by the electrical load;
a battery-demand modulator panel (eBATT) which determines the battery charge status of the battery power supply and the power being supplied thereto; and
an energy gateway processor (EGP) which receives information from the battery-demand modulator panel (eBATT) regarding the battery charge status of the battery power supply and the power being supplied thereto and information from the energy monitoring panel (EMP) regarding the power from the grid and solar power supplies used by the electrical load;
wherein the battery-demand modulator panel (eBATT) modulates the battery power supply, in response to a signal from the energy gateway processor (EGP), to adjust the grid power used by the electrical load.

2. The system of claim 1, wherein the battery-demand modulator panel (eBATT) reduces the grid power used by the electrical load during peak periods to reduce the cost.

3. The system of claim 1, wherein the battery-demand modulator panel (eBATT) increases the battery power supply used during peak periods to reduce the cost.

4. The system of claim 1, wherein the battery-demand modulator panel (eBATT) adjusts the battery power during peak demand periods to reduce demand charges.

5. The system of claim 1, wherein the battery-demand modulator panel (eBATT) increases the battery power as the solar power decreases.

6. The system of claim 1, wherein the energy gateway processor (EGP) determines the battery power supplied in response to determining the total power used by the electrical load and solar power supplied.

7. The system of claim 1, wherein the operation of the battery power supply is adjusted by the energy gateway processor (EGP) in response to adjustments in solar power provided by the solar power supply.

8. A system, comprising:
an electrical load which receives an aggregate power signal having grid, battery, and solar power supply components;
an energy monitoring panel (EMP) which determines the grid and solar power components;
a battery-demand modulator panel (eBATT) which determines a charge cycle for a battery power supply; and
an energy gateway processor (EGP) which receives information from the battery-demand modulator panel (eBATT) regarding the charge cycle for the battery power supply and information from the energy monitoring panel (EMP) regarding the grid and solar power components;
wherein the battery-demand modulator panel (eBATT) modulates the charge cycle for the battery power supply, in response to a signal from the energy gateway processor (EGP), to adjust the battery power supply component of the aggregate power signal.

9. The system of claim 8, wherein the battery-demand modulator panel (eBATT) reduces the grid power supply component during peak periods to reduce the cost.

10. The system of claim 8, wherein the battery-demand modulator panel (eBATT) increases the battery power supply component used during peak periods to reduce the cost.

11. The system of claim 8, wherein the battery-demand modulator panel (eBATT) adjusts the battery power supply component during peak demand periods to reduce demand charges.

12. The system of claim 8, wherein the battery-demand modulator panel (eBATT) increases the battery power supply component as the solar power supply component decreases.

13. The system of claim 8, wherein the energy gateway processor (EGP) determines the battery power supply component in response to determining the grid and solar power supply components.

14. The system of claim 8, wherein the energy monitoring panel (EMP) determines the grid and solar power components at a predetermined rate.

15. The system of claim 14, wherein the predetermined rate is adjustable in response to an indication that the grid and solar power components are changing.

16. A system, comprising:
a plurality of electrical loads, each of which receives an aggregate power signal having grid, battery, and solar power supply components;
a plurality of relays operatively coupled to corresponding electrical loads of the plurality of electrical loads;
an energy monitoring panel (EMP) which determines the grid and solar power components;
a battery-demand modulator panel (eBATT) which determines a charge cycle for a battery power supply; and
an energy gateway processor (EGP) which receives information from the battery-demand modulator panel (eBATT) regarding the charge cycle for the battery power supply and information from the energy monitoring panel (EMP) regarding the grid and solar power components;
wherein the energy gateway processor (EGP) adjusts the operation of the relays and the battery-demand modulator panel (eBATT) modulates the charge cycle for the battery power supply, in response to a signal from the energy gateway processor (EGP), to adjust the battery power supply component of the aggregate power signal to provide a desired aggregate power signal.

17. The system of claim 16, wherein the energy gateway processor (EGP) limits the aggregate power signal in response to an indication that the aggregate power signal exceeds a predetermined power value.

18. The system of claim 16, wherein the energy gateway processor (EGP) limits the aggregate power signal in response to an indication that the aggregate power signal exceeds a predetermined monetary value.

19. The system of claim 16, wherein pertinent data is gathered at very high frequency and a network is created to use this data in algorithms at the energy gateway processor (EGP) for fully automated control of the power drawn from the battery power supply.

20. The system of claim 16, wherein the energy gateway processor (EGP) operates the battery-demand modulator panel (eBATT) so that the battery power supply is enabled to operate through a set time period.
